(19) United States
(12) Patent Application Publication
(10) Pub. No.: US 2014/0287195 A1
(43) Pub. Date: Sep. 25, 2014

(54) PRODUCTION METHOD AND TOOL FOR PRODUCING AN EQUIPMENT PART, AND EQUIPMENT PART FOR A VEHICLE

(71) Applicants: Manfred Mai, Neufahrn (DE); Jesus Galan, Duesseldorf (DE); Francisco Acedo, Koeln (DE); Dieter Kerkhoff, Leichlingen (DE); Bruno Schröder, Viersen (DE); Cristoph Grun, Kempen (DE); Norberto Silva, Essen (DE); Robert Weber, Krefeld (DE)

(72) Inventors: Manfred Mai, Neufahrn (DE); Jesus Galan, Duesseldorf (DE); Francisco Acedo, Koeln (DE); Dieter Kerkhoff, Leichlingen (DE); Bruno Schröder, Viersen (DE); Cristoph Grun, Kempen (DE); Norberto Silva, Essen (DE); Robert Weber, Krefeld (DE)

(73) Assignee: JOHNSON CONTROLS INTERIORS GmbH & Co. KG, Grefrath (DE)

(21) Appl. No.: 14/240,135

(22) PCT Filed: Jul. 4, 2012
(86) PCT No.: PCT/EP2012/062989

§ 371 Date: Jun. 11, 2014

(30) Foreign Application Priority Data
Aug. 24, 2011 (DE) 10 2011 111 058.9
Dec. 13, 2011 (DE) 10 2011 120 826.0

(51) Int. Cl. B60R 13/02; B32B 38/00

(52) U.S. Cl. CPC B60R 13/02; B32B 38/0012
USPC 428/174; 156/212; 156/64; 156/535; 156/214

(57) ABSTRACT

The invention rotates to a method for producing an equipment part (1). According to the invention, the equipment part (1) is provided with a decorative skin (2) at least in some sections, wherein the decorative skin (2) is integrated with at least two differently colored and/or different structured material regions (2.1, 2.2) then are adjacent to one another along a separating line (3), wherein the separating line (3) of the material regions (2.1, 2.2) of the decorative skin (2) that are adjacent to one another is oriented in correspondence with a recess (12) of the equipment part (1) substantially pointing away from the visible side and then deepens into the recess (12) of the equipment part (1) in a form-closed manner in the area of the separating line (3) and is fastened in a bonded manner. The invention further relates to a tool for producing an equipment part (1). The invention further relates to an equipment part (1) for arrangement in a vehicle.

### BACKGROUND OF THE INVENTION

The invention relates to a method for producing an equipment part. Furthermore, the invention relates to a tool for producing an equipment part, in particular for the interior of a motor vehicle. Furthermore, the invention relates to an equipment part, in particular for the interior of a motor vehicle.

Tools with holding means, a molding area and transport devices for feeding a film into the tool are generally known.

### SUMMARY OF THE INVENTION

The present invention provides, in one aspect, a method for producing an equipment part including providing a decorative skin integrally formed with at least two different material regions that are adjacent each other along a separating line, orienting the separating line with a groove-shaped depression in the equipment part pointing away from a visible side of the equipment part, recessing the skin into the depression in a form-fitting manner in the region of the separating line, and integrally bonding the skin to the equipment part.

The present invention provides, in another aspect, a tool for producing an equipment part. The tool includes at least one grooved blade that is shaped in a manner corresponding to a depression, which points away from a visible side, of the equipment part. The blade has a projecting region that is pressed into the depression to at least partially deform a decorative skin and form a depression in the decorative skin.

The present invention provides, in yet another aspect, an equipment part for arrangement in a vehicle. The equipment part includes at least one groove-shaped depression that points away from a visible side of the equipment part and in which a separating line between mutually adjacent material regions of a decorative skin is arranged.

It is the object of the present invention to specify a method for producing an equipment part, which method is improved by comparison to the prior art, an improved tool for producing an equipment part and an improved equipment part.

In the method for producing an equipment part, the equipment part is at least partially provided, according to the invention, with a decorative skin, wherein the decorative skin is integrally formed with at least two differently colored and/or different structured material regions which are adjacent to each other along a separating line, wherein the separating line of the mutually adjacent material regions of the decorative skin is oriented in a manner corresponding to a depression, which substantially points away from a visible side, of the equipment part and is subsequently recessed into the depression of the equipment part in a form-fitting manner in the region of the separating line and is fastened in a form-fitting and/or integrally bonded manner. The separating line is thereby arranged in a concealed manner, and a visually attractive transition between the two differently colored and/or different structured material regions is achieved on a surface of the equipment part.

The depression here is preferably designed as a conventional groove with a U-shaped cross section, but, in alternative variant embodiments, can also be formed as a double groove or with a W-shaped cross section.

Expediently, a position and/or orientation of the separating line between the differently colored and/or different structured material regions is visually detected and compared with a position and/or a profile of the groove-shaped depression in the equipment part, wherein the separating line is subsequently oriented congruently to the groove-shaped depression in a manner corresponding to the position and/or the profile thereof. This permits an error-reduced and automated orientation of separating line and depression.

In particular, the separating line is arranged at a defined position in a holding means of the tool for carrying out the method.

The decorative skin is particularly preferably at least partially moved with respect to the equipment part. As a result, a position of the separating line is changeable and is matchable to a profile of the depression.

The visual detection here takes place by means of at least one corresponding, conventional, optical sensor, preferably by means of at least one camera, in particular a linear array camera, a 3D camera, a stereo camera or a plurality of cameras.

Advantageously, during or after an orientation of the decorative skin, the position and/or orientation of the separating line is/are compared at least once with a desired position and/or a desired orientation, wherein, in the event of a deviation of the detected position and/or orientation of the separating line from the predetermined desired position and/or the desired orientation, the orientation of the decorative skin is matched to the separating line. As a result, the position and/or the orientation of the held decorative skin can be corrected.

Particularly advantageously, the position and/or orientation of the separating line is/are continuously compared with the desired position and/or the desired orientation. The held decorative skin can therefore be re-oriented continuously or at a predetermined position in the manufacturing process depending on the determined difference between actual position and/or actual orientation and desired position and/or desired orientation.

A depression can expediently be introduced into the decorative skin at ambient or room temperature or in a heated state.

In a particularly advantageous embodiment, the decorative skin, before being applied to the equipment part, is pre-shaped three-dimensionally, in particular by means of a thermoforming operation. Such a pre-shaping facilitates the subsequent application of the decorative skin to a three-dimensionally shaped equipment part.

The tool for producing an equipment part comprises at least one grooved blade which is shaped in a manner corresponding to a depression, which points away from a visible side, of the equipment part and has a projecting region which is pressable into the depression, wherein, during the pressing of the projecting region of the grooved blade into the depression, a decorative skin is at least partially deformed, forming a depression. By means of such a grooved blade, a simple and efficient option for forming the depression in the decorative skin is provided.

The tool furthermore comprises at least one holding means with at least one gripper element by means of which the decorative skin is at least partially orientable in at least one degree of freedom within the holding means and is multiply fixable. A position and/or orientation of the separating line here can be changed by the partial orientation of the decorative skin.

The grooved blade is expediently shiftable relative to the holding means and/or to the gripper element, in particular is displaceable orthogonally to a surface of the held decorative skin.

In a particularly advantageous embodiment, at least two grooved blades which are positionable independently of each other are arranged on the tool. As a result, a plurality of depressions can be produced in the decorative skin concerned in one working step.

An equipment part for arrangement in a vehicle has, according to the invention, at least one groove-shaped depression which points away from the visible side and in which a separating line between mutually adjacent material regions of a decorative skin is arranged. The separating line between mutually adjacent material regions is thereby arranged in a manner protected from sight, as a result of which a quality appearance of the equipment part is significantly increased.

An integrally bonded connection is advantageously formed between decorative skin and equipment part in the region of the depression. This permits a permanent and durable arrangement of the decorative skin in the depression of the equipment part.

The separating line between mutually adjacent material regions of the decorative skin is particularly advantageously arranged on a side wall of the depression, and therefore the visibility of said separating line is further reduced.

In order to produce an attractive haptics of the equipment part and to cushion same, a foam layer is arranged between the equipment part and decorative skin.

### BRIEF DESCRIPTION OF THE DRAWINGS

Exemplary embodiments of the invention are explained in more detail below with reference to drawings, in which:

FIG. 1 schematically shows a blank and the positioning of a decorative skin during use of the method according to the invention,

FIG. 2 schematically shows the decorative skin, equipment part and tool during preparation of the method according to the invention,

FIG. 3 schematically shows the decorative skin and equipment part after carrying out the method according to the invention,

FIG. 4 schematically shows an equipment part which is coated with a decorative skin by means of the method according to the invention,

FIG. 5 schematically shows an illustration of a detail of the equipment part coated with a decorative skin,

FIG. 6 schematically shows a first method step for producing an equipment part coated with a decorative skin,

FIG. 7 schematically shows a second method step for producing an equipment part coated with a decorative skin,

FIG. 8 schematically shows a third method step for producing an equipment part coated with a decorative skin,

FIG. 9 schematically shows a fourth method step for producing an equipment part coated with a decorative skin,

FIG. 10 schematically shows a fifth method step for producing an equipment part coated with a decorative skin,

FIG. 11 schematically shows a sixth method step for producing an equipment part coated with a decorative skin,

FIG. 12 schematically shows a seventh method step for producing an equipment part coated with a decorative skin,

FIG. 13 schematically shows an eighth method step for producing an equipment part coated with a decorative skin,

FIG. 14 schematically shows a ninth method step for producing an equipment part coated with a decorative skin,

FIG. 15 schematically shows a tenth method step for producing an equipment part coated with a decorative skin,

FIG. 16 schematically shows an eleventh method step for producing an equipment part coated with a decorative skin,

FIG. 17 schematically shows a twelfth method step for producing an equipment part coated with a decorative skin,

FIG. 18 schematically shows a thirteenth method step for producing an equipment part coated with a decorative skin, and

FIG. 19 schematically shows a fourteenth method step for producing an equipment part coated with a decorative skin.

Parts corresponding to one another are provided with the same reference numbers in all of the drawings.

### DETAILED DESCRIPTION

By means of the method according to the invention, an equipment part 1 is at least partially coated in an integrally bonded manner with a decorative skin 2, in particular in a visible region. A tool used for carrying out the method is formed at least from an upper die 8 and a lower die in the form of a deforming tool, in particular in the form of a thermo-deforming tool.

The equipment part 1 can be, for example, a lining part for an interior of a vehicle, for example a vehicle door, a vehicle frame or a dashboard.

At least one groove-shaped depression 12 is formed in the equipment part 1.

The equipment part 1 here is provided in a manufacturing process with a decorative skin 2 having at least two in particular differently colored and/or differently structured material regions 2.1, 2.2.

The decorative skin 2 is preferably integrally formed with at least two preferably differently colored and/or differently structured material regions 2.1, 2.2 which are adjacent to each other along a separating line 3.

The decorative skin 2 is preferably composed of a plastics film, for example made of polyvinyl chloride (PVC) or a thermoplastic elastomer, in particular on an olefinic basis (TPO).

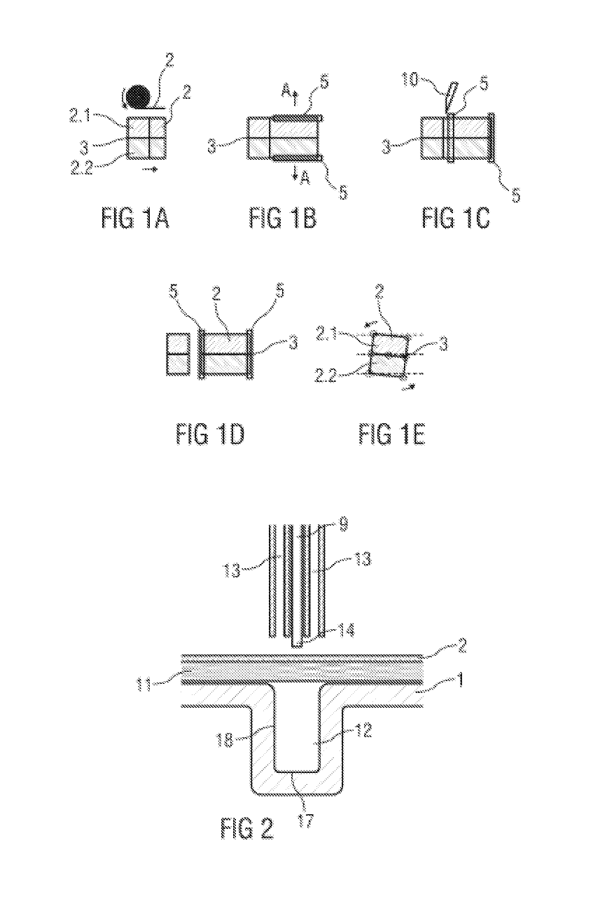

In order to prepare the method according to the invention for manufacturing an equipment part 1 with a decorative skin 2 with at least two material regions 2.1, 2.2, the, for example, two-colored semifinished product for the decorative skin 2 is pulled off from a roller, as schematically illustrated in FIG. 1a, and smoothed by stretching in the transverse direction, as schematically illustrated in FIG. 1b (arrows A).

The decorative skin 2 is subsequently grasped by gripper elements 5 and cut to length by means of a knife 10, as schematically illustrated in FIGS. 1c and 1d.

In the exemplary embodiment, the transition or the separating line 3 between the differently colored and/or differently structured material regions 2.1, 2.2 runs in the longitudinal direction of the semi-finished product and therefore transversely with respect to the section direction. The precise profile of the separating line 3 can be visually detected and brought into correspondence with a predetermined profile, as schematically illustrated in FIG. 1e.

The trimmed semi-finished product of the decorative skin 2, which is already laminated on the rear side in the exemplary embodiment with a foam layer 11, is then positioned over the stiff, in particular dimensionally stable equipment part 1, which is provided with a groove-shaped depression 12 and is to be coated, for example using negative pressure connections 13 which fix the decorative skin 2 by means of negative pressure, as schematically illustrated in FIG. 2.

The groove-shaped depression 12 is preferably compressed in the direction of the surface in such a manner that the material regions are in contact in the region of the deflection into the depression 12 or at least form a minimized spacing. The bottom of the depression 12 becomes invisible or at least difficult to see by this means.

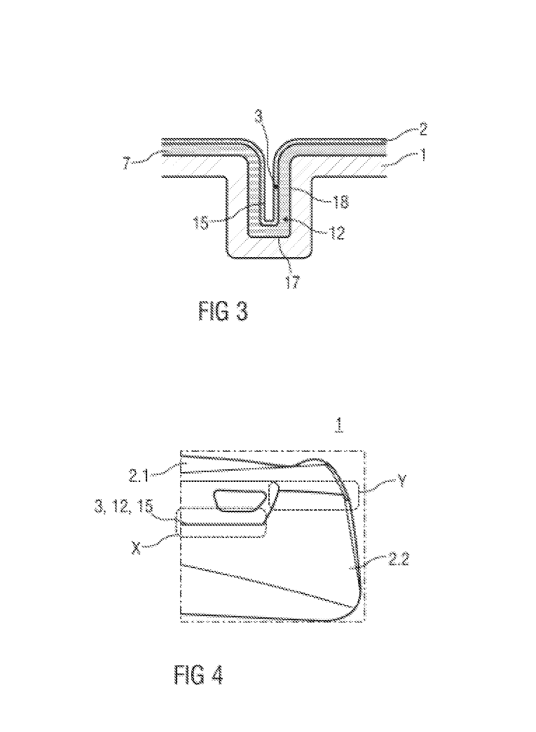

A projecting region 14 of the tool which is designed as what is referred to as a groove blade 9, said region being provided between the negative pressure connections 13 and being displaceable relative to the latter in the direction of the depression 12, is subsequently dipped into the depression 12 of the equipment part 1, as a result of which a depression 15 is also formed in the decorative skin 2, as schematically illustrated in FIG. 3.

The depression 12 is preferably of groove-shaped design, with the separating line 3 between the material regions 2.1, 2.2 running substantially linearly within the depression 12.

The depression 15 can be introduced into the decorative skin 2 at ambient or room temperature, but also in a heated state. Furthermore, provision may be made for the decorative skin 2 to be pre-shaped three-dimensionally, for example by thermoforming, before introduction of the depression 12 of the equipment part.

In the exemplary embodiment, the separating line 3 is not arranged in a groove bottom 17, but rather on one of the side walls 18 of the depression 12, in order further to reduce the visibility thereof.

The depression 15 in the decorative skin 2 is preferably entirely or virtually closed by application of a shearing force after removal of the grooved blade 9. The shearing force is produced in particular by the foaming pressure or the elastic restoring force of a foam layer 11 introduced between the decorative skin 2 and the equipment part 1.

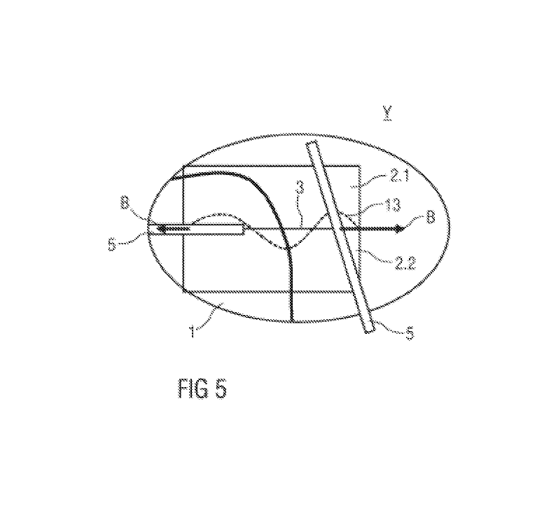

FIG. 4 schematically shows an equipment part 1 which is designed as a door lining for a motor vehicle and in which part of the separating line 3 is arranged in the region X in a depression 12.

Another region Y of the separating line 3 between the material regions 2.1, 2.2 of the decorative skin 2 is provided in a flat manner. In order to compensate for position tolerances, in particular undulations 16, in the region Y, the separating line 3 there, before application to the equipment part 1, can be stretched in the longitudinal direction B. This procedure can expressly also be advantageous if a depression 12 is entirely omitted and the separating line 3 therefore lies completely in the visible region.

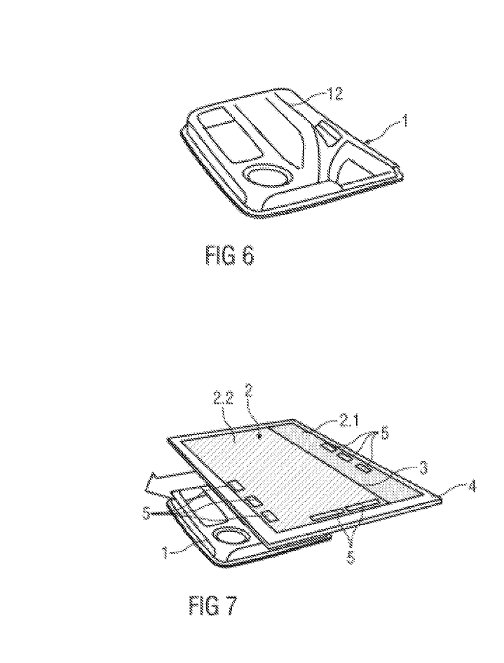

FIG. 6 schematically shows a first method step for producing an equipment part 1 which is coated with a decorative skin 2 and in which an equipment part 1 is placed into a tool (not illustrated).

FIG. 7 schematically shows a second method step for producing the equipment part 1, in which the decorative skin 2 is held in a frame-shaped holding means 4, which is part of the tool, and is positioned above the equipment part 1 by means of said holding means 4. The holding means 4 is preferably designed as a rigid clamping frame in which the decorative skin 2 or a blank of the decorative skin 2 is fixed.

Furthermore, the holding means 4 comprises at least one gripper element 5 by means of which the decorative skin 2 or the blank can be oriented and re-fixed in at least one degree of freedom, preferably in at least two or three degrees of freedom x, y or z, within the holding means 4.

In particular, the gripper element 5 can be designed as a tongs element which grips an edge-side end of the decorative skin 2.

Alternatively or additionally, the gripper element 5 can be designed as a nozzle or can comprise a nozzle which has a negative pressure connection 13 and thereby sucks up and fixes the decorative skin 2 by means of negative pressure.

The gripper element or the gripper elements 5 are movable mechanically, pneumatically or electrically, as a result of which the decorative skin 2 held in the holding means 4 or the held blank of said decorative skin is oriented, in particular stretched, tensioned, distorted or elongated, in at least two degrees of freedom −x, x, y within the holding means 4 and relative thereto.

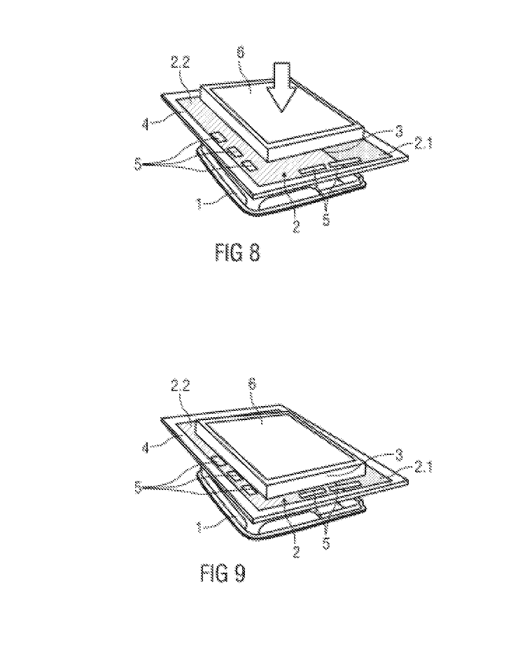

FIG. 8 schematically shows a third method step for producing the equipment part 1, in which a heating device 6 is positioned above the decorative skin 2.

FIG. 9 schematically shows a fourth method step for producing the equipment part 1, in which the decorative skin 2 is heated by means of the heating device 6.

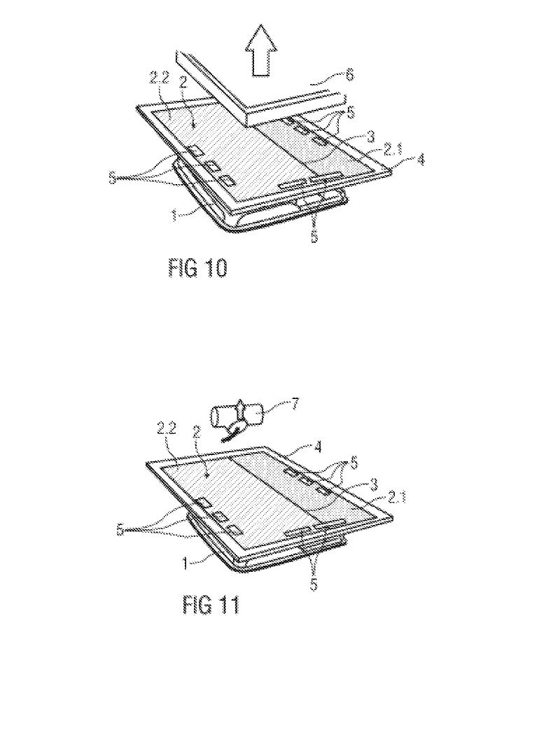

FIG. 10 schematically shows a fifth method step for producing the equipment part 1, in which the heating device 6 is removed from the tool.

FIG. 11 schematically shows a sixth method step for producing the equipment part 1, in which a position and/or orientation of the separating line 3 between the differently colored material regions 2.1, 2.2 of the decorative skin 2 is visually detected by means of a sensor arrangement 7.

The sensor arrangement 7 is arranged above the held decorative skin 2 and serves for detecting the decorative skin 2 held in the holding means 4, in particular the separating line 3 thereof between the material regions 2.1, 2.2. The sensor arrangement 7 is designed, for example, as a camera, in particular a linear array camera, a 3D camera, a stereo camera. A plurality of cameras can also be provided.

Furthermore, the position and/or the orientation of the separating line 3 between the differently colored material regions 2.1, 2.2 is compared with a position and/or a profile of the groove-shaped depression 12 in the equipment part 1.

FIG. 12 schematically shows a seventh method step for producing the equipment part 1, in which the heated decorative skin 2 and, in particular, the separating line 3 thereof is oriented and/or positioned by means of the gripper elements 5 in such a manner that the separating line 3 in the decorative skin 2 and the groove-shaped depression 12 in the equipment part 1 are arranged congruently.

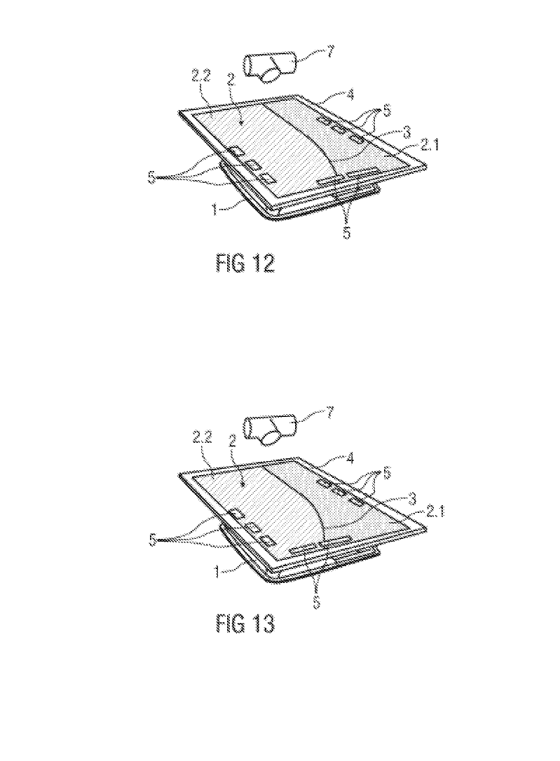

FIG. 13 schematically shows an eighth method step for producing the equipment part 1, in which a positioning, which is referred to as a pre-elongation operation, and/or orienting of decorative skin 2 and separating line 3 is ended.

FIG. 14 schematically shows a ninth method step for producing the equipment part 1, in which an upper die 8 is lowered onto the decorative skin 2.

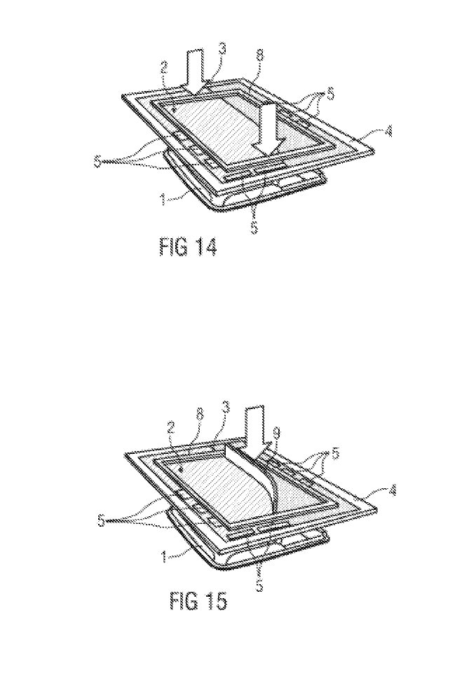

FIG. 15 schematically shows a tenth method step for producing the equipment part 1, in which at least one what is referred to as a grooved blade 9, which is, for example, part of the upper die 8 and has a shaping corresponding to the groove-shaped depression 12 of the equipment part 1, is pressed into the groove-shaped depression 12 of the equipment part 1. As a result, a depression 15 corresponding to the groove-shaped depression 12 of the equipment part 1 is formed in the decorative skin 2 in the region of the separating line 3.

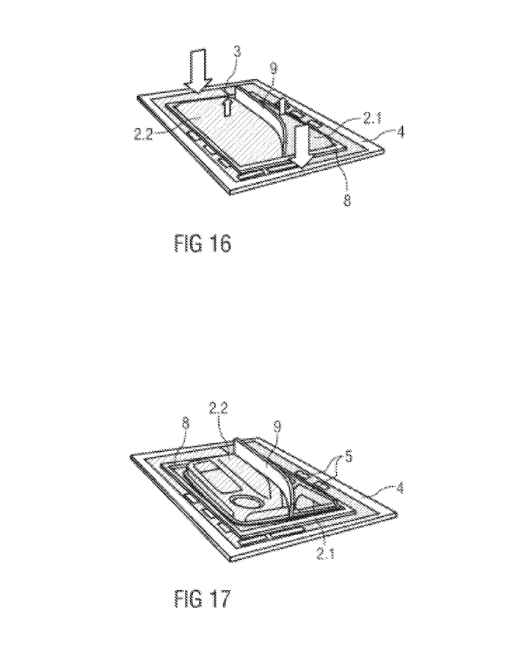

FIG. 16 schematically shows an eleventh method step for producing the equipment part 1, in which the upper die 8 with the decorative skin 2 arranged thereon is lowered in such a manner that the full area of the decorative skin 2 rests on a surface of the equipment part 1 to be coated.

FIG. 17 schematically shows a twelfth method step for manufacturing the equipment part 1, in which the decorative skin 2 is pressed and/or laminated in a conventional manner, for example by application of a negative pressure to the lower die, onto the surface of the equipment part 1 to be coated.

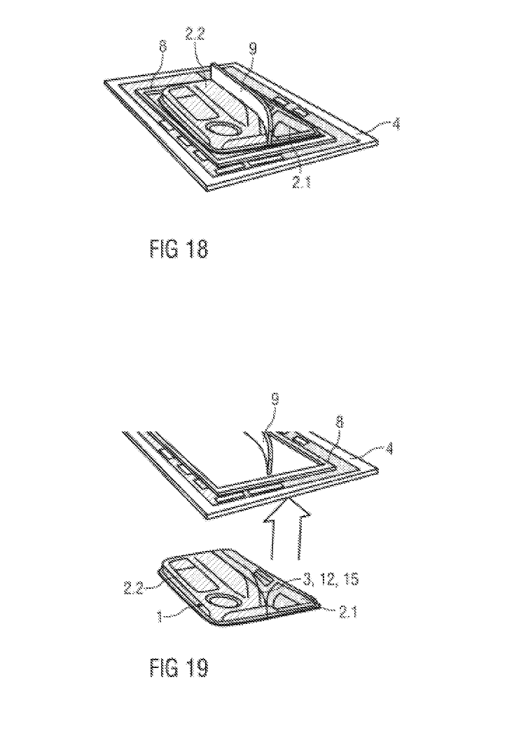

FIG. 18 schematically shows a thirteenth method step for producing the equipment part 1, in which the equipment part 1 remains in the tool for the duration of a predeterminable laminating period.

FIG. 19 schematically shows a fourteenth method step for producing the equipment part 1, in which the coated equipment part 1, which now has differently colored material regions 2.1, 2.2 on the surface side, is removed from the tool.

In the fourteenth method step, the decorative skin 2 and the equipment part 1 are therefore deformed in a manner corresponding to each other by means of the tool, which is in the form of a die, and are connected to each other preferably in an integrally bonded manner.

Various features of the invention are set forth in the following claims.

1. A method for producing an equipment part, the method comprising:
providing a decorative skin integrally formed with at least two different material regions that are adjacent each other along a separating line;
orienting the separating line with a groove-shaped depression in the equipment part pointing away from a visible side of the equipment part;
recessing the skin into the depression in a form-fitting manner in the region of the separating line; and
integrally bonding the skin to the equipment part.

2. The method as claimed in claim 1, further comprising:
visually detecting at least one of a position an orientation of the separating line;
comparing the at least one of the position and orientation of the separating line with at least one of a position and a profile of the groove-shaped depression in the equipment part; and
orienting the separating line congruently to the groove-shaped depression.

3. The method as claimed in claim 1, further comprising moving the decorative skin with respect to the equipment part.

4. The method as claimed in claim 1, further comprising:
comparing the at least one of the position and the orientation of the separating line at least once with at least one of a desired position and a desired orientation; and
matching the orientation of the decorative skin to the separating line in the event of a deviation of one of the detected position and the orientation of the separating line from the one of the predetermined desired position and the desired orientation.

5. The method as claimed in claim 4, further comprising continuously comparing at least one of the position and orientation of the separating line with one of the desired position the desired orientation of the separating line.

6. The method as claimed in claim 1, further comprising introducing the depression into the decorative skin at one of an ambient or room temperature and a heated state.

7. The method as claimed in claim 1, further comprising pre-shaping the decorative skin, three-dimensionally before being applied to the equipment part by a thermoforming operation.

8. A tool for producing an equipment part, comprising at least one grooved blade that is shaped in a manner corresponding to a depression, which points away from a visible side, of the equipment part, the blade having a projecting region that is pressed into the depression to at least partially deform a decorative skin and form a depression in the decorative skin.

9. The tool as claimed in claim 8, further comprising at least one holding means with at least one gripper element by which the decorative skin is at least partially orientable in at least one degree of freedom within the holding means and is multiply fixable.

10. The tool as claimed in claim 8, wherein the grooved blade is shiftable relative to at least one of the holding means and the gripper element, and wherein the blade is displaceable orthogonally to a surface of the decorative skin.

11. The tool as claimed in claim 8, wherein the grooved blade is a first grooved blade, and wherein the tool further includes a second grooved blade that is positionable independently of the first grooved blade.

12. An equipment part for arrangement in a vehicle, comprising at least one groove-shaped depression that points away from a visible side of the equipment part and in which a separating line between mutually adjacent material regions of a decorative skin is arranged.

13. The equipment part as claimed in claim 12, wherein an integrally bonded connection is formed between the decorative skin and the equipment part in a region of the depression.

14. The equipment part as claimed in claim 12, wherein the separating line between mutually adjacent material regions of the decorative skin is arranged on a side wall of the depression.

15. The equipment part as claimed in claim 12, further comprising a foam layer is arranged between the equipment part and the decorative skin.

16. The method as claimed in claim 2, further comprising moving the decorative skin with respect to the equipment part.

17. The method as claimed in claim 5, further comprising introducing the depression into the decorative skin at one of an ambient or room temperature and a heated state.

18. The method as claimed in claim 17, further comprising pre-shaping the decorative skin three-dimensionally before being applied to the equipment part by a thermoforming operation.

19. The tool as claimed in claim 9, wherein the grooved blade is shiftable relative to at least one of the holding means and the gripper element, and wherein the blade is displaceable orthogonally to a surface of the decorative skin.

20. The equipment part as claimed in claim 13, wherein the separating line between mutually adjacent material regions of the decorative skin is arranged on a side wall of the depression.
